(19) United States
(12) Patent Application Publication
(10) Pub. No.: US 2010/0143756 A1
(43) Pub. Date: Jun. 10, 2010

(54) CONNECTING APPARATUS IN FUEL CELL SYSTEM AND FUEL CELL SYSTEM INCLUDING THE CONNECTING APPARATUS

(75) Inventors: Jin S. HEO, Suwon-si (KR); Takami Higashi, Suwon-si (KR); Dong-kwan Kim, Hwaseong-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd, Suwon-si (KR)

(21) Appl. No.: 12/579,671

(22) Filed: Oct. 15, 2009

(30) Foreign Application Priority Data
Dec. 4, 2008 (KR) 10-2008-0122389

(51) Int. Cl. H01M 8/04

(52) U.S. Cl. 429/22

(57) ABSTRACT

A connecting apparatus in a fuel cell system and a fuel cell system including the connecting apparatus include a pipe module and a controller controlling the operation of the pipe module. The pipe module includes a first valve connecting a fuel processor and an anode of a stack, a second valve connecting an automatic drain and a heat exchanger, and a check valve connecting the anode of the stack and the heat exchanger.

### CROSS-REFERENCE TO RELATED APPLICATION

This application claims the benefit of Korean Patent Application No. 10-2008-0122389, filed Dec. 4, 2008, in the Korean Intellectual Property Office, the disclosure of which is incorporated herein by reference.

### BACKGROUND

1. Field

Aspects herein relate to a connecting apparatus in a fuel cell system and a fuel cell system including the connecting apparatus.

2. Description of the Related Art

In general, a fuel cell is a power generation device that directly converts chemical energy of a fuel into electrical energy through a chemical reaction. The fuel cell can continuously generate electricity as long as the fuel is supplied thereto.

FIG. 1 is a block diagram of a conventional fuel cell system 100. Referring to FIG. 1, the conventional fuel cell system 100 includes a fuel processor 110 to reform a hydrocarbon-containing fuel gas to hydrogen gas (H₂), a burner 112 to heat the fuel processor 110, a stack 120 to generate electricity by using the hydrogen gas (H₂) supplied from the fuel processor 110, a power converter 130 to convert direct current (DC) power generated by the stack 120 into alternating current (AC) power, a hot water tank 140 to store water for retrieving and to store heat generated by the stack 120, a first water pump 150 to supply water to the fuel processor 110, a fuel pump 160 to supply a fuel, such as city gas, liquefied petroleum gas (LPG), or kerosene, to the fuel processor 110 and the burner 112, a first air pump 170 to supply air used to combust the fuel to the burner 112, a second water pump 180 to supply water stored in the hot water tank 140 to the stack 120, and a second air pump 190 to supply oxygen gas (O₂) in the air to the stack 120.

Accordingly, a fuel gas, a reformed gas obtained by reforming the fuel gas, and air flow through pipes between the above-described elements of the conventional fuel cell system 100. In particular, since hydrogen gas, which can be obtained by reforming the fuel gas, flows from the fuel processor 110 to the stack 120 through a pipe passage, leakage and heat loss occurring in the pipe passage need to be reduced. However, the conventional fuel cell system 100 is problematic in that since the fuel processor 110 and the stack 120 are connected to each other by linking individual connecting parts 195, such as by valves, pipes, and drain separators, the length of the pipe passage is increased with each connecting part 195 connected, and therefore, leakage and heat loss is increased. Also, as the number of connected parts 195 is increased, material costs are increased; and as the number of assembly processes is increased, the number of manufacturing processes is increased.

### SUMMARY

Aspects provide a connecting apparatus in a fuel cell system that can reduce heat loss and costs by combining a plurality of connecting parts in the fuel cell system into one module. Aspects of the present invention also provide a fuel cell system including a pipe module that combines a plurality of connecting parts in the fuel cell system.

According to aspects, there is provided a connecting apparatus to connect a fuel processor and a stack in a fuel cell system that includes the fuel processor, the stack, an automatic drain, and a heat exchanger, the connecting apparatus including: a pipe module including: a first valve having a first inlet connected to the fuel processor, a first outlet connected to an inlet of an anode of the stack, and a second outlet, wherein the first outlet opens and closes; a second valve comprising a second inlet connected to the second outlet of the first valve, a third outlet connected to the automatic drain, and a fourth outlet connected to the heat exchanger, wherein the fourth outlet opens and closes; and a check valve comprising a third inlet connected to an outlet of the anode of the stack and a fifth outlet connected to the heat exchanger, the check valve controlling flow from the third inlet to the fifth outlet; and a controller to control the operation of the pipe module.

According to aspects, the pipe module may further include a third valve having a fourth inlet and a sixth outlet connected to the inlet of the anode of the stack, wherein the sixth outlet opens and closes.

According to aspects, there is provided a fuel cell system including: a fuel processor to reform an input gas to a reformed gas comprising hydrogen gas; a stack to receive the reformed gas from the fuel processor and to generate electricity from the reformed gas; an automatic drain to remove water contained in the reformed gas; and a heat exchanger to decrease the temperature of a gas supplied from the stack to the fuel processor to remove moisture contained in the gas; a pipe module including a plurality of valves, the pipe module connecting the fuel processor, the stack, the automatic drain, and the heat exchanger via the plurality of valves; and a controller to control the operation of the pipe module.

According to aspects, the pipe module may comprise: a first valve having a first inlet connected to the fuel processor, a first outlet connected to an inlet of an anode of the stack, and a second outlet, wherein the first outlet opens and closes; a second valve having a second inlet connected to the second outlet of the first valve, a third outlet connected to the automatic drain, and a fourth outlet connected to the heat exchanger, wherein the fourth outlet opens and closes; and a check valve comprising a third inlet connected to an outlet of the anode of the stack and a fifth outlet connected to the heat exchanger, the check valve controlling flow from the third inlet to the fifth outlet.

Additional aspects and/or advantages will be set forth in part in the description which follows and, in part, will be obvious from the description, or may be learned by practice of the invention.

### BRIEF DESCRIPTION OF THE DRAWINGS

These and/or other aspects and advantages will become more apparent and more readily appreciated from the following description of the embodiments, taken in conjunction with the accompanying drawings of which:

FIG. 1 is a block diagram of a conventional fuel cell system;

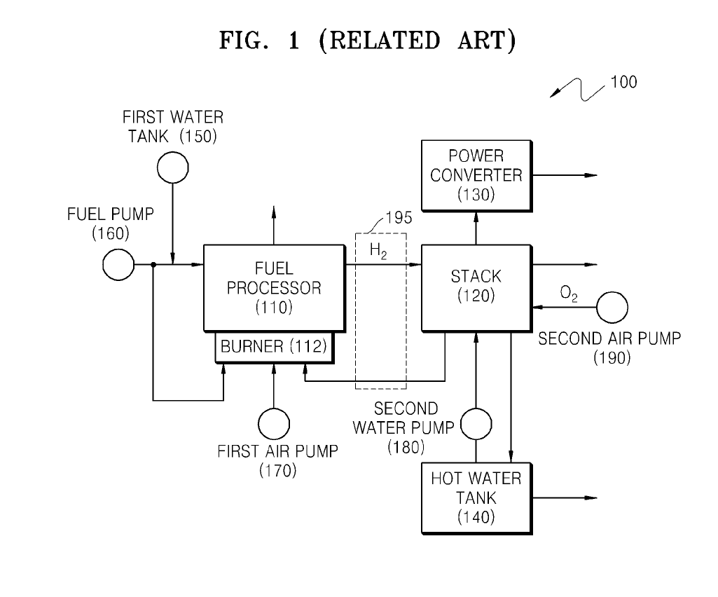

FIG. 2 is a block diagram of a fuel cell system according to an exemplary embodiment;

FIG. 3 illustrates a connecting apparatus in the fuel cell system of FIG. 2, according to an exemplary embodiment;

FIG. 4 illustrates a connecting apparatus in the fuel cell system of FIG. 2, according to an exemplary embodiment;

FIG. 5 is a flowchart illustrating a method of operating the connecting apparatus of FIG. 3 in the fuel cell system of FIG. 2, according to an exemplary embodiment;

FIG. 6 illustrates a flow of a reformed gas in a start-up mode of the connecting apparatus of FIG. 3 in the fuel cell system of FIG. 2, according to an exemplary embodiment;

FIG. 7 illustrates a flow of a reformed gas in a normal mode of the connecting apparatus of FIG. 3 in the fuel cell system of FIG. 2, according to an exemplary embodiment;

FIG. 8 is a flowchart illustrating a method of operating the connecting apparatus of FIG. 4 in the fuel cell system of FIG. 2, according to an exemplary embodiment;

FIG. 9 illustrates a flow of a reformed gas in a start-up mode of the connecting apparatus of FIG. 4 in the fuel cell system of FIG. 2, according to an exemplary embodiment;

FIG. 10 illustrates a flow of a reformed gas in a normal mode of the connecting apparatus of FIG. 4 in the fuel cell system of FIG. 2, according to an exemplary embodiment;

FIG. 11 illustrates a flow of a nitrogen gas when the nitrogen gas purges the connecting apparatus of FIG. 4 in the fuel cell system of FIG. 2, according to an exemplary embodiment; and

FIG. 12 illustrates a flow of a hydrogen gas when the hydrogen gas is directly supplied to the connecting apparatus of FIG. 4 in the fuel cell system of FIG. 2, according to an exemplary embodiment.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

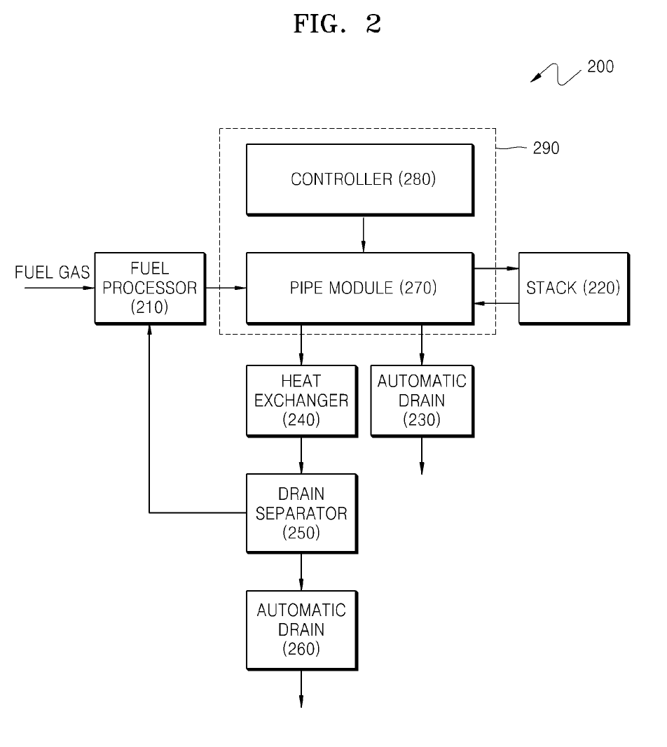

FIG. 2 is a block diagram of a fuel cell system 200 according to an exemplary embodiment. Referring to FIG. 2, the fuel cell system 200 includes a fuel processor 210, a stack 220, automatic drains 230 and 260, a heat exchanger 240, a drain separator 250, a pipe module 270, and a controller 280. The fuel cell system 200 includes a connecting apparatus 290, which comprises the pipe module 270 and the controller 280.

The fuel processor 210 reforms an input fuel gas into a reformed gas, which includes hydrogen gas. The stack 220 receives the reformed gas from the fuel processor 210 and generates power by using the reformed gas. The automatic drains 230 and 260 remove water contained in the reformed gas. The heat exchanger 240 reduces the temperature of a gas supplied from the stack 220 to a burner of the fuel processor 210 in order to remove moisture from the gas. The drain separator 250 separates the condensate from the gas. The pipe module 270 includes a plurality of valves and connects the fuel processor 210 and the stack 220 via the plurality of valves. The controller 280 controls the operation of the pipe module 270.

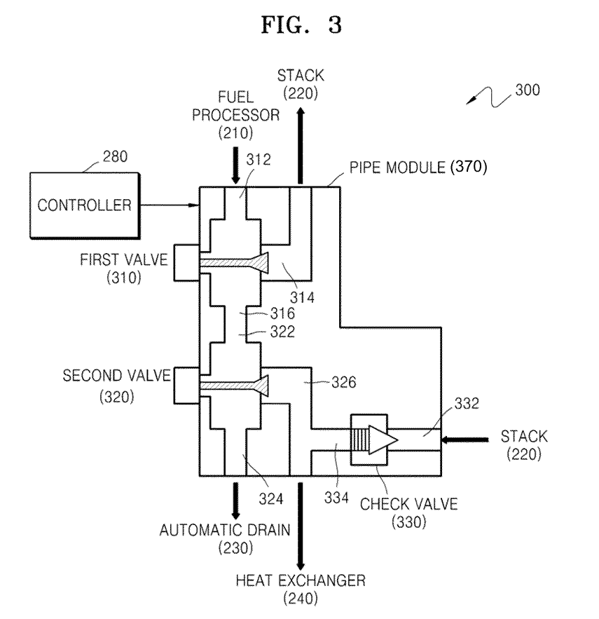

FIG. 3 illustrates a connecting apparatus 300 available for use in the fuel cell system 200 of FIG. 2, according to an embodiment. Referring to FIG. 3, the connecting apparatus 300 corresponds to the connecting apparatus 290 that connects the fuel processor 210 and the stack 220 and comprises a pipe module 370 and the controller 280 in the fuel cell system 200 of FIG. 2. The pipe module 370 includes a first valve 310, a second valve 320, and a check valve 330.

The first valve 310 includes a first inlet 312 connected to the fuel processor 210, a first outlet 314 connected to an inlet of an anode of the stack 220, and a second outlet 316. The first outlet 314 is opened and closed according to control signals generated by the controller 280. For example, whether the first valve 310 is opened or closed determines whether the first outlet 314 is opened or closed, respectively. Accordingly, reformed gas supplied to the first inlet 312 may be discharged to the first outlet 314 or the second outlet 316 depending on whether the first valve 310 is opened or closed, respectively.

The second valve 320 includes a second inlet 322 connected to the second outlet 316 of the first valve 310, a third outlet 324 connected to the automatic drain 230, and a fourth outlet 326 connected to the heat exchanger 240 and the check valve 330. The fourth outlet 326 is opened and closed according to control signals generated by the controller 280. That is, whether the second valve 320 is opened or closed determines whether the fourth outlet 326 is opened or closed, respectively. If the second valve 320 is opened, the reformed gas supplied to the second inlet 322 may be discharged to the fourth outlet 326 and water contained in the reformed gas supplied to the second inlet 322 and condensed via pipes may be automatically discharged to the automatic drain 230 through the third outlet 324.

The check valve 330 includes a third inlet 332 connected to an outlet of the anode of the stack 220 and a fifth outlet 334 connected to the heat exchanger 240. The fifth outlet 334 is opened and closed in one direction. If a gas is supplied from the outlet of the anode of the stack 220 to the third inlet 332 and a pressure higher than a predetermined pressure is applied to the check valve 330, the check valve 330 may be automatically opened and thus the gas supplied to the third inlet 332 may be discharged to the fifth outlet 334.

The controller 280 controls the operation of the pipe module 370. For example, the controller 280 opens or closes the first valve 310 and the second valve 320 of the pipe module 370.

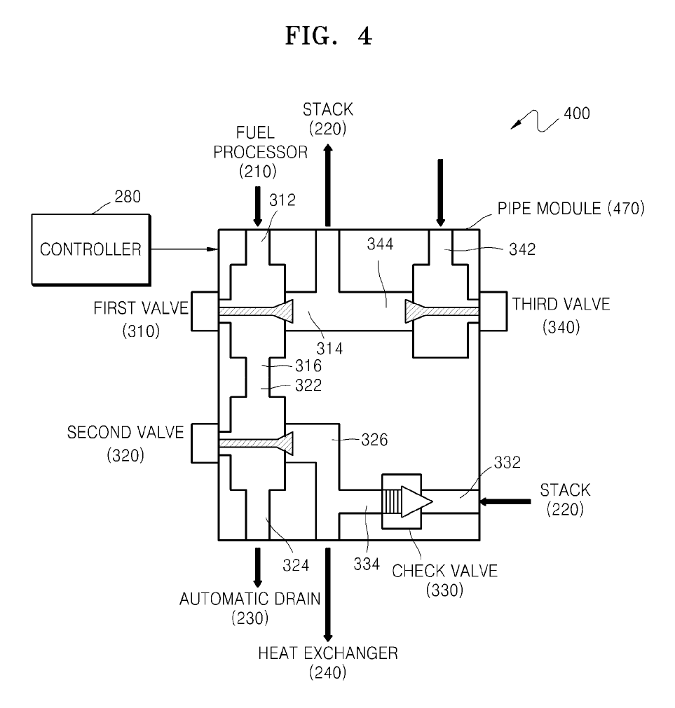

FIG. 4 illustrates a connecting apparatus 400 available for use in the fuel cell system 200 of FIG. 2, according to another embodiment. Referring to FIG. 4, the pipe module 470 of the connecting apparatus 400 further includes a third valve 340. For example, the pipe module 470 of the connecting apparatus 400 of FIG. 4 includes the third valve 340 in addition to the first valve 310, the second valve 320, and the check valve 330 as described above with respect to the pipe module 370 of the connecting apparatus 300 of FIG. 3. The third valve 340 includes a fourth inlet 342 connected to a secondary gas source (not shown) and a sixth outlet 344 connected to the inlet of the anode of the stack 220. The sixth outlet 344 is opened and closed according to control signals generated by the controller 280. The controller 280 of the connecting apparatus 400 of FIG. 4 controls the first valve 310, the second valve 320, and the third valve 340 of the pipe module 470.

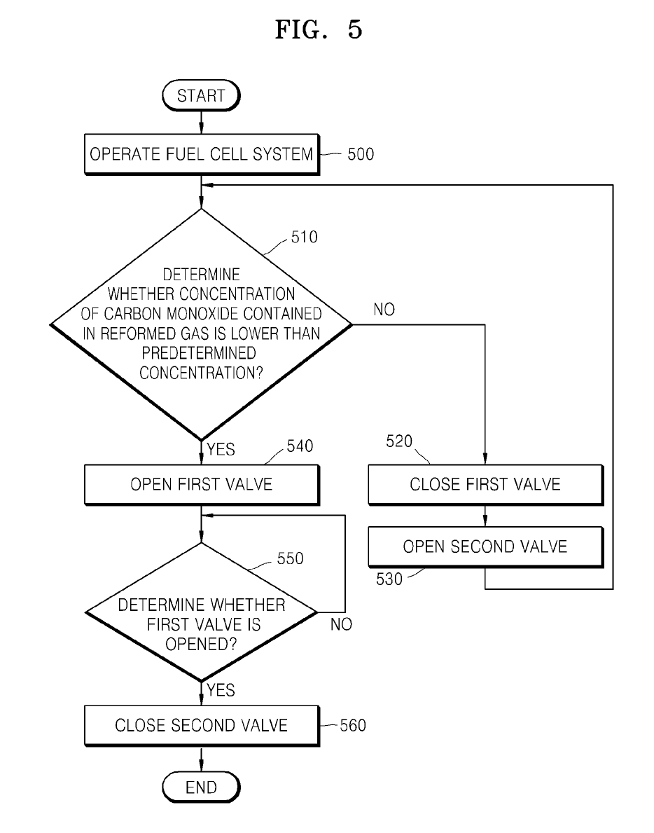

FIG. 5 is a flowchart illustrating a method of operating the connecting apparatus 300 of FIG. 3 in the fuel cell system 200 of FIG. 2, according to an embodiment.

In operation 500, operation of the fuel cell system 200 is started. The fuel processor 210 performs a reforming reaction and discharges reformed gas. The fuel processor 210 initially performs the reforming reaction of operation 500 in a start-up mode, wherein the fuel processor 210 produces and discharges a reformed gas containing a high concentration of carbon monoxide. If the fuel processor 210 performs the reforming reaction for a predetermined period of time, the concentration of carbon monoxide contained in the reformed gas is gradually reduced. The reforming reaction eventually enters a normal mode, wherein the fuel processor 210 produces reformed gas containing carbon monoxide at a concentration that is lower than a predetermined concentration, and the reformed gas is then discharged from the fuel processor 210. Here, the predetermined concentration refers to a concentration required for the stack 220 to generate electricity. The stack 220 can generate electricity by using a reformed gas produced from the fuel processor 210 in a normal mode.

In operation 510, it is determined whether the concentration of carbon monoxide contained in the reformed gas is lower than the predetermined concentration. That is, it is determined in operation 510 whether the fuel cell system 200 is in a start-up mode or a normal mode based on the concentration of carbon monoxide contained in the reformed gas. If it is determined in operation 510 that the concentration of carbon monoxide contained in the reformed gas is lower than the predetermined concentration, the method proceeds to operation 540. Otherwise, the method proceeds to operation 520. Whether the fuel cell system 200 is in a normal mode may be determined by measuring the temperature of the fuel processor 210 to determine the concentration of carbon monoxide contained in the reformed gas. For example, if the temperature of a portion of the fuel processor 210 is higher than a temperature at which the concentration of the carbon monoxide to be changed to a concentration lower than the predetermined concentration, it is determined that the fuel cell system 200 is in the normal mode.

In operation 520, the first valve 310 is closed. For example, if the reformed gas containing carbon monoxide having a concentration higher than the predetermined concentration is supplied from the fuel processor 210 to the first inlet 312, the controller 280 closes the first valve 310.

In operation 530, the second valve 320 is opened. The controller 280 opens the second valve 320 when the first valve 310 of the pipe module 270 is closed. The method returns to operation 510.

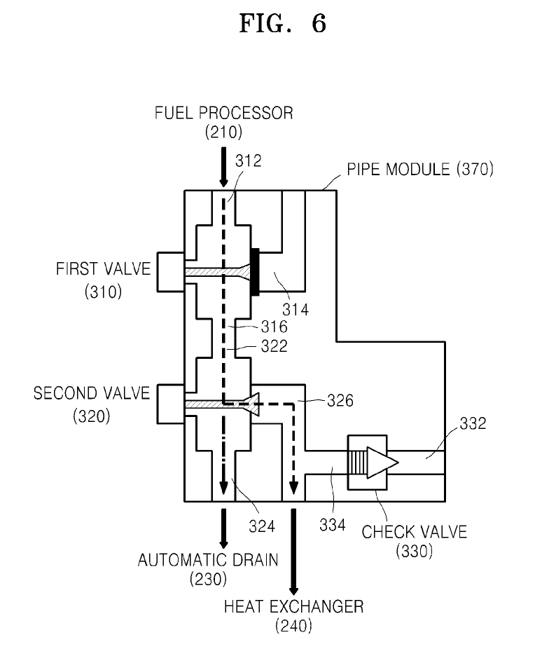

FIG. 6 illustrates a flow of the reformed gas in a start-up mode of the connecting apparatus 300 of FIG. 3 in the fuel cell system 200 of FIG. 2, according to an embodiment. Referring to FIG. 6, if the controller 280 closes the first valve 310 of the pipe module 370 in operation 520 and opens the second valve 320 in operation 530, the first valve 310 and the second valve 320 condense vapor contained in the reformed gas. The condensate is discharged to the third outlet 324 and supplied to the automatic drain 230, and the reformed gas from which the vapor is removed is discharged to the fourth outlet 326 and supplied to the heat exchanger 240.

Referring to FIG. 5 again, in operation 540, the first valve 310 is opened. In operation 550, it is determined whether the first value 310 is opened. Operation 550 is repeated until it is determined that the first vale 310 is opened. In operation 560, the second valve 320 is closed.

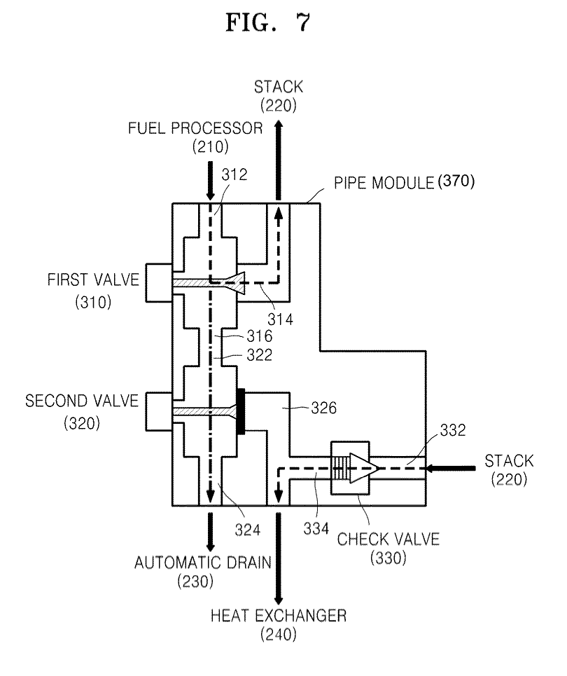

FIG. 7 illustrates a flow of the reformed gas in a normal mode of the connecting apparatus 300 of FIG. 3 in the fuel cell system 200 of FIG. 2, according to an embodiment. Referring to FIG. 7, if the controller 280 opens the first valve 310 in operation 540 and closes the second valve 320 in operation 560, the first valve 310 and the second valve 320 separate the vapor contained in the reformed gas. Accordingly, the pipe module 270 including the first valve 310 and the second valve 320 may be a drain separator that separates the vapor contained in the reformed gas and removes the condensate from the reformed gas. The condensate obtained by separating the vapor contained in the reformed gas is discharged to the third outlet 324 and supplied to the automatic drain 230, and the reformed gas from which the vapor is removed is discharged to the first outlet 314 to the inlet of the anode of the stack 220. Once the reformed gas is supplied to the inlet of the anode of the stack 220, an anode off gas generated as a hydrogen component of the reformed gas is consumed due to an electrochemical reaction is discharged to the outlet of the anode of the stack 220. The discharged anode off gas is supplied to the third inlet 332. Once the anode off gas is supplied to the third inlet 332, the check valve 330 is automatically opened due to a sufficient pressure of the anode off gas, and the anode off gas is discharged to the fifth outlet 334 and supplied to the heat exchanger 240.

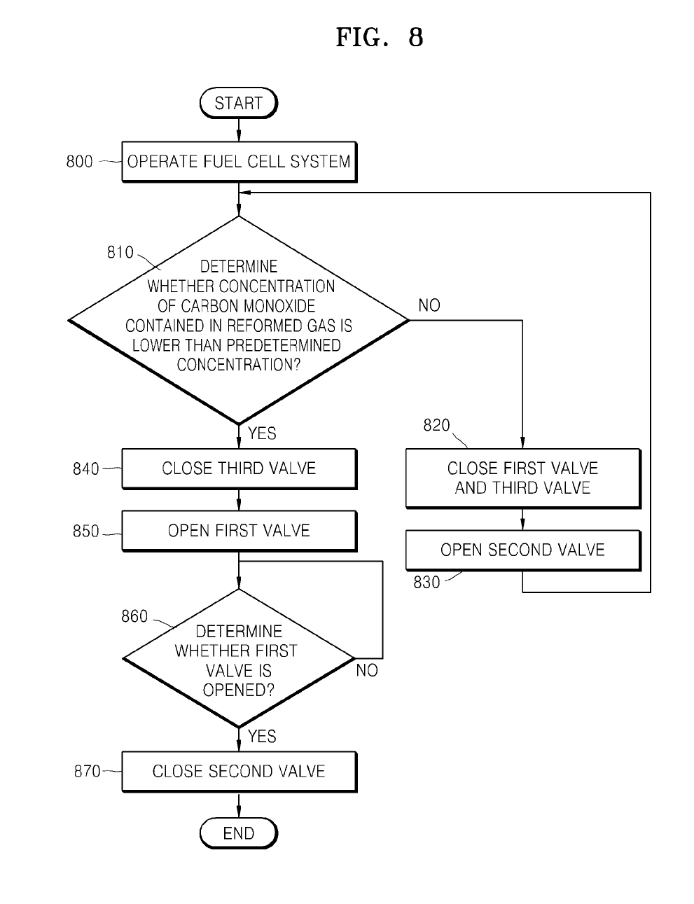

FIG. 8 is a flowchart illustrating a method of operating the connecting apparatus 400 of FIG. 4 in the fuel cell system 200 of FIG. 2, according to another embodiment. In operation 800, operation of the fuel cell system 200 is started. Once operation of the fuel cell system 200 is started, the fuel processor 210 performs a reforming reaction and discharges reformed gas.

In operation 810, it is determined whether the concentration of carbon monoxide contained in the reformed gas is lower than a predetermined concentration. For example, it is determined whether the fuel cell system 200 is in a start-up mode or a normal mode based on the concentration of carbon monoxide contained in the reformed gas. If it is determined in operation 810 that the concentration of carbon monoxide contained in the reformed gas is lower than the predetermined concentration, the method proceeds to operation 840. Otherwise, the method proceeds to operation 820. For example, it is determined in operation 810 whether the fuel cell system 200 is in a normal mode. Whether the fuel cell system 200 is in a normal mode may be determined by measuring the temperature of the fuel processor 210. For example, if the temperature of a portion of the fuel processor 210 is higher than a temperature at which the concentration of carbon monoxide to be changed to a concentration lower than the predetermined concentration, it is determined that the fuel cell system 200 is in the normal mode. If it is determined in operation 810 that the fuel cell system 200 is in a normal mode, the method proceeds to operation 840; otherwise, the method proceeds to operation 820.

In operation 820, the first valve 310 and the third valve 340 are closed. If reformed gas containing carbon monoxide having a concentration higher than the predetermined concentration is supplied from the fuel processor 210 to the first inlet 312, the controller 280 closes the first valve 310.

In operation 830, the second valve 320 is opened. The controller 280 opens the second valve 320 when the first valve 310 of the pipe module 470 is closed. The method then returns to operation 810.

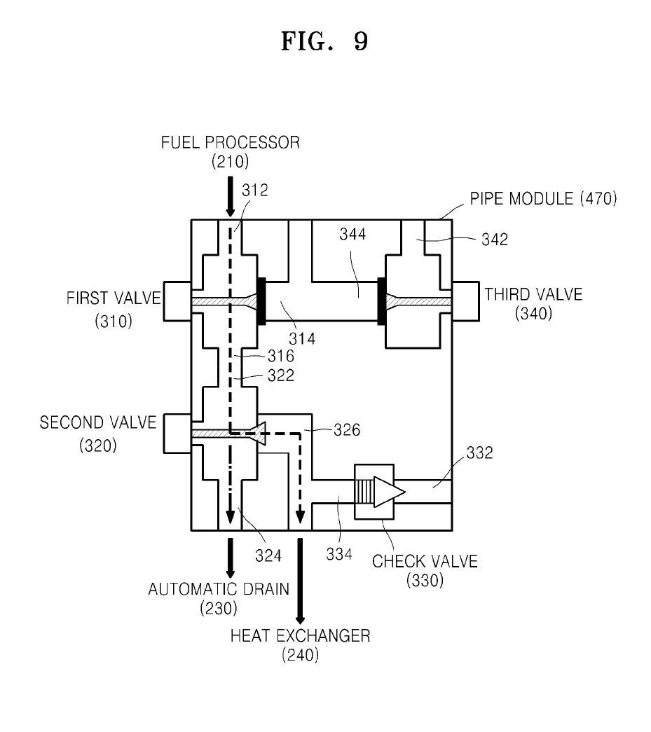

FIG. 9 illustrates a flow of the reformed gas in a start-up mode of the connecting apparatus 400 of FIG. 4 in the fuel cell system 200 of FIG. 2, according to another embodiment. Referring to FIG. 9, if the controller 280 closes the first valve 310 and the third valve 340 of the pipe module 270 in operation 820 and opens the second valve 320 in operation 830, the first valve 310 and the second valve 320 separate the vapor contained in the reformed gas. Accordingly, the pipe module 270 including the first valve 310 and the second valve 320 may be a drain separator that separates the vapor contained in the reformed gas and removes the condensate from the reformed gas. The condensate is discharged to the third outlet 324 and supplied to the automatic drain 230, and the reformed gas from which the vapor is removed is discharged to the fourth outlet 326 and supplied to the heat exchanger 240.

Referring to FIG. 8 again, in operation 840, the third valve 340 is closed. In operation 850, the first valve 310 is opened. The controller 280 opens the first valve 310 when the third valve 340 is closed.

In operation 860, it is determined whether the first valve 310 is opened. Operation 860 is repeated until it is determined that the first valve 310 is opened.

In operation 870, the second valve 320 is closed. The controller 280 closes the second valve 320 when the third valve 340 is closed and the first valve 310 is opened.

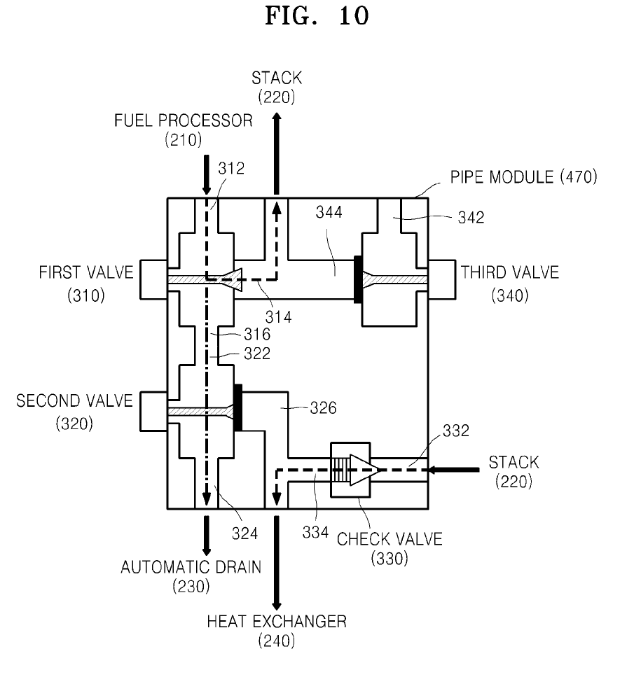

FIG. 10 illustrates a flow of the reformed gas in a normal mode of the connecting apparatus 400 of FIG. 4 in the fuel cell system 200 of FIG. 2, according to an embodiment. Referring to FIG. 10, if the controller 280 opens the first valve 310 in operation 850 when the third valve 340 is closed, and closes the second valve 320 in operation 870, the first valve 310 and the second valve 320 separate the vapor contained in the reformed gas. Accordingly, the pipe module 270 including the first valve 310 and the second valve 320 may be a drain separator that separates the vapor contained in the reformed gas and removes the condensate from the reformed gas. The condensate is discharged to the third outlet 324 and supplied to the automatic drain 230, and the reformed gas from which the vapor is removed is discharged to the first outlet 314 and supplied to the inlet of the anode of the stack 220. Once the reformed gas is supplied to the inlet of the anode of the stack 220, an anode off gas, which generated as a hydrogen component of the reformed gas is consumed due to an electrochemical reaction, is discharged to the outlet of the anode of the stack 220. The discharged anode off gas is supplied to the third inlet 332. Once the anode off gas is supplied to the third inlet 332, the check valve 330 is automatically opened due to a sufficient pressure of the anode off gas, and the anode off gas is discharged to the fifth outlet 334 and supplied to the heat exchanger 240.

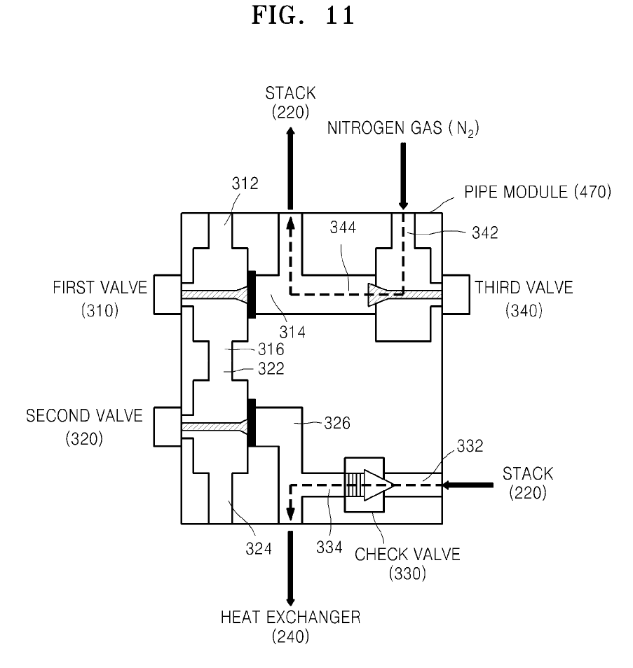

FIG. 11 illustrates a flow of nitrogen gas to purge the connecting apparatus 400 of FIG. 4 in the fuel cell system 200 of FIG. 2, according to an embodiment. If the fuel cell system 200 is normally stopped or an emergency situation occurs, the reformed gas may be purged from the anode of the stack 220, and the voltage of a cell in the stack 220 can be reduced by supplying a purging gas, e.g., nitrogen gas (N₂), from the secondary gas source to the inlet of the anode of the stack 220. In this case, the third valve 340 is opened when the first valve 310 and the second valve 320 are closed. Referring to FIG. 11, nitrogen gas is supplied to the fourth inlet 342 and is discharged to the sixth outlet 344 and supplied to the inlet of the anode of the stack 220. Once the nitrogen gas is supplied to the inlet of the anode of the stack 220, the nitrogen gas helps to purge the anode of the stack 220, and an anode off gas generated after the purging is discharged to the outlet of the anode of the stack 220. The discharged anode off gas is supplied to the third inlet 332. Once the anode off gas is supplied to the third inlet 332, the check valve 330 is automatically opened due to a sufficient pressure of the anode off gas, and the anode off gas is discharged to the fifth outlet 334 and supplied to the heat exchanger 240.

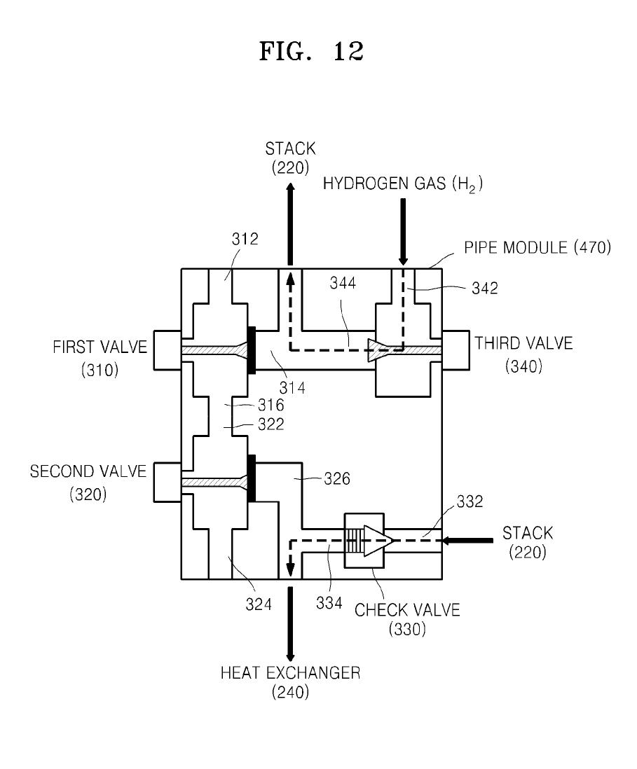

FIG. 12 illustrates a flow of hydrogen gas when the hydrogen gas is directly supplied to the connecting apparatus 400 of FIG. 4 in the fuel cell system 200 of FIG. 2, according to an embodiment. In general, hydrogen gas is generated through a reforming reaction in the fuel processor 210, and is supplied to the anode of the stack 220 through the connecting apparatus 290, 300, 400. However, another device other than the fuel processor 210 may directly supply hydrogen gas to the stack 220. As shown in FIG. 11, when hydrogen gas is directly supplied to the connecting apparatus 400 of FIG. 4 in the fuel cell system 200 of FIG. 2, the third valve 340 is opened and the first valve 310 and the second valve 320 are closed. The hydrogen gas supplied to the third valve 340 is discharged to the sixth outlet 344 and supplied to the inlet of the anode of the stack 220. Once the hydrogen gas is supplied to the inlet of the anode of the stack 220, an anode off gas generated as a hydrogen gas component is consumed due to an electrochemical reaction is discharged to the outlet of the anode of the stack 220. The discharged anode off gas is supplied to the third inlet 332. Once the anode off gas is supplied to the third inlet 332, the check valve 330 is automatically opened due to a sufficient pressure of the anode off gas, and the anode off gas is discharged to the fifth outlet 334 and supplied to the heat exchanger 240.

Aspects may be written as computer programs and can be implemented in general-use digital computers that execute the programs using a computer readable recording medium. Aspects may be recorded on a computer-readable recording medium. Examples of the computer-readable recording medium include storage media, such as magnetic storage media (e.g., read only memories (ROMs), floppy discs, or hard discs), and optically readable media (e.g., compact disk-read only memories (CD-ROMs), or digital versatile disks (DVDs)).

Although a few embodiments have been shown and described, it would be appreciated by those skilled in the art that changes may be made without departing from the principles and spirit thereof, the scope of which is defined in the claims and their equivalents.

What is claimed is:

1. A connecting apparatus to connect a fuel processor and a stack in a fuel cell system that comprises the fuel processor, the stack, an automatic drain, and a heat exchanger, the connecting apparatus comprising:
a pipe module, comprising:
a first valve having a first inlet connected to the fuel processor, a first outlet connected to an inlet of an anode of the stack, and a second outlet, wherein the first outlet opens and closes,
a second valve having a second inlet connected to the second outlet of the first valve, a third outlet connected to the automatic drain, and a fourth outlet connected to the heat exchanger, wherein the fourth outlet opens and closes, and
a check valve having a third inlet connected to an outlet of the anode of the stack and a fifth outlet connected to the heat exchanger, the check valve controlling flow from the third inlet to the fifth outlet; and
a controller to control the operation of the pipe module.

2. The connecting apparatus of claim 1, wherein the pipe module further comprises a third valve having a fourth inlet and a sixth outlet connected to the inlet of the anode of the stack, wherein the sixth outlet opens and closes.

3. The connecting apparatus of claim 1, wherein, if a reformed gas containing carbon monoxide having a concentration that is higher than a predetermined concentration is supplied from the fuel processor to the first inlet, the controller closes the first valve and opens the second valve such that the first valve and the second valve separate vapor contained in the reformed gas to supply water obtained by condensing the vapor contained in the reformed gas to the automatic drain and to supply the reformed gas from which the vapor is removed to the heat exchanger.

4. The connecting apparatus of claim 1, wherein, if reformed gas containing carbon monoxide having a concentration that is higher than a predetermined concentration is supplied from the fuel processor to the first inlet, the controller closes the second valve and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

5. The connecting apparatus of claim 1, wherein, if the temperature of a portion of the fuel processor is higher than a temperature at which the concentration of the carbon monoxide to be changed to a concentration lower than the predetermined concentration, the controller closes the second valve and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

6. The connecting apparatus of claim 2, wherein, if nitrogen gas is supplied to the third inlet, the controller closes the first valve and the second valve and opens the third valve, such that the nitrogen gas is supplied to the anode of the stack, and
if an anode off gas generated after the nitrogen gas supplied to the anode of the stack is supplied from the anode of the stack to the third inlet, the check valve is automatically opened to supply the anode off gas to the heat exchanger via the fifth outlet.

7. The connecting apparatus of claim 2, wherein, if hydrogen gas is supplied to the third inlet, the controller closes the first valve and the second valve and opens the third valve, such that the hydrogen gas is supplied to the anode of the stack, and
if an anode off gas generated as the hydrogen gas is consumed due to an electrochemical reaction in the stack is supplied from the anode of the stack to the third inlet, the check valve is automatically opened to supply the anode off gas to the heat exchanger via the fifth outlet.

8. The connecting apparatus of claim 2, wherein, if reformed gas containing carbon monoxide having a concentration that is higher than a predetermined concentration is supplied from the fuel processor to the first inlet, the controller closes the second valve, closes the third valve, and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

9. The connecting apparatus of claim 2, wherein, if the temperature of a portion of the fuel processor is higher than a temperature at which the concentration of the carbon monoxide to be changed to a concentration lower than the predetermined concentration, the controller closes the second valve, closes the third valve, and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

10. A fuel cell system comprising:
a fuel processor to reform an input gas to a reformed gas comprising hydrogen gas;
a stack to receive the reformed gas from the fuel processor and to generate electricity from the reformed gas;
an automatic drain to remove water contained in the reformed gas; and
a heat exchanger to decrease the temperature of a gas supplied from the stack to the fuel processor to remove moisture contained in the gas;
a pipe module comprising a plurality of valves, the pipe module connecting the fuel processor, the stack, the automatic drain, and the heat exchanger via the plurality of valves; and
a controller to control the operation of the pipe module.

11. The fuel cell system of claim 10, wherein the pipe module comprises:
a first valve having a first inlet connected to the fuel processor, a first outlet connected to an inlet of an anode of the stack, and a second outlet, wherein the first outlet opens and closes;
a second valve having a second inlet connected to the second outlet of the first valve, a third outlet connected to the automatic drain, and a fourth outlet connected to the heat exchanger, wherein the fourth outlet opens and closes; and
a check valve comprising a third inlet connected to an outlet of the anode of the stack and a fifth outlet connected to the heat exchanger, the check valve controlling flow from the third inlet to the fifth outlet.

12. The fuel cell system of claim 11, wherein the pipe module further comprises a third valve having a fourth inlet and a sixth outlet connected to the inlet of the anode of the stack, wherein the sixth outlet is opens and closes.

13. The fuel cell system of claim 11, wherein, if the reformed gas containing carbon monoxide having a concentration that is higher than a predetermined concentration is supplied from the fuel processor to the first inlet,
the controller closes the first valve and opens the second valve such that the first valve and the second valve separate vapor contained in the reformed gas to supply water obtained by condensing the vapor contained in the reformed gas to the automatic drain and to supply the reformed gas from which the vapor is removed to the heat exchanger.

14. The fuel cell system of claim 11, wherein, if the reformed gas containing a carbon monoxide having a concentration that is lower than a predetermined concentration is supplied from the fuel processor to the first inlet, the controller closes the second valve and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

15. The fuel cell system of claim 11, wherein, if the temperature of a portion of the fuel processor is higher than a temperature at which the concentration of the carbon monoxide to be changed to a concentration lower than the predetermined concentration, the controller closes the second valve and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

16. The fuel cell system of claim 12, wherein, if nitrogen gas is supplied to the third inlet, the controller closes the first valve and the second valve and opens the third valve, such that the nitrogen gas is supplied to the anode of the stack, and
if an anode off gas generated after the nitrogen gas supplied to the anode of the stack is supplied from the anode of the stack to the third inlet, the check valve is automatically opened to supply the anode off gas to the heat exchanger the fifth outlet.

17. The fuel cell system of claim 12, wherein, if hydrogen gas is supplied to the third inlet, the controller closes the first valve and the second valve and opens the third valve such that the hydrogen gas is supplied to the anode of the stack, and
if an anode off gas generated as the hydrogen gas is consumed due to an electrochemical reaction in the stack is supplied from the anode of the stack to the third inlet, the check valve is automatically opened to supply the anode off gas to the heat exchanger via the fifth outlet.

18. The connecting apparatus of claim 12, wherein, if reformed gas containing carbon monoxide having a concentration that is higher than a predetermined concentration is supplied from the fuel processor to the first inlet, the controller closes the second valve, closes the third valve, and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.

19. The connecting apparatus of claim 12, wherein, if the temperature of a portion of the fuel processor is higher than a temperature at which the concentration of the carbon monoxide to be changed to a concentration lower than the predetermined concentration, the controller closes the second valve, closes the third valve, and opens the first valve such that the first valve and the second valve separate vapor contained in the reformed gas to supply water obtained by condensing the vapor contained in the reformed gas to the automatic drain and to supply the reformed gas from which the vapor is removed to the anode of the stack, and
if an anode off gas generated as a hydrogen component of the reformed gas is consumed due to an electrochemical reaction in the stack is supplied from the anode of the stack to the third inlet, the check valve is automatically opened to supply the anode off gas to the heat exchanger via the fifth outlet.
